(19) United States
(12) Patent Application Publication
(10) Pub. No.: US 2003/0078164 A1
(43) Pub. Date: Apr. 24, 2003

(54) Method for control of bacterial spot

(76) Inventor: Nader Soltani, London (CA)

Correspondence Address: Eric Fincham, 316 Knowlton Road, Lac Brome, QC, JOE 1VO, CA

(21) Appl. No.: 10/225,668

(22) Filed: Aug. 22, 2002

(30) Foreign Application Priority Data
Aug. 24, 2001 (CA) 2,355,812

(51) Int. Cl. A01N 63/00

(52) U.S. Cl. 504/117

(57) ABSTRACT

A method and composition for the control of bacterial spot and bacterial speck diseases which comprises the step of foliarly spraying on a plant on which the disease is to be controlled a bactericidally amount of a lignosulfonate. In a preferred embodiment, a monophosphate salt is incorporated in a composition including the lignosulfonate.

### FIELD OF THE INVENTION

The present invention relates to a method for the control of bacterial spot.

### BACKGROUND OF THE INVENTION

Bacterial spot (Xanthomonas vesicatoria) is a serious and persistent problem for tomato and pepper growers. Infected plants lose blossoms, defoliate and produce a severely-spotted unsaleable fruit. Although disease severity varies significantly from year to year, bacterial spot can reduce yield by as much as 50%. Bacterial speck (Pseudomonas syringae pv. tomato), often found in association with bacterial spot, also contributes to yield loss.

To date, varieties which are resistant to bacterial spot have not been developed. The disease, as aforementioned, reduces yields significantly and fruit having the disease can not be utilized even for processing.

In order to attempt to control bacterial spot, growers have generally relied on copper based bactericides. While they do show activity against the disease, the compounds can be difficult to apply and may not always be effective due to weather conditions.

Generally, growers find one of the most effective environmentally acceptable ways of controlling the disease is to visually inspect the transplant seedlings or seeds before the planting begins. However, such a method is a relatively crude one and does not help once the disease develops in the field.

### SUMMARY OF THE INVENTION

It is an object of the present invention to provide a method for the control of bacterial spot disease.

It is a further object of the present invention to provide a method for the control of bacterial speck diseases.

It is a still further object of the present invention to provide a composition useful for the control of bacterial spot and speck disease.

In one aspect of the present invention, there is provided a method for the control of bacterial spot and bacterial speck diseases, the method comprising the step of foliarly spraying on a plant on which said bacterial spot and bacterial speck is to be controlled a bactericidally effective amount of a lignosulfonate.

According to one aspect of the present invention, there is provided a method for the control of bacterial spot, the method comprising the step of spraying a composition on a plant on which the bacterial spot is to be controlled, the composition comprising between about 0.5% and about 4% by weight of a lignosulfonate, and between 96% and 99.5% by weight of water.

In a further aspect of the present invention, there is provided a method for the control of bacterial speck, the method comprising the step of spraying a composition on a plant on which the bacterial speck is to be controlled, the composition comprising between about 0.5% and about 4% by weight of a lignosulfonate, and between about 95% and about 99.5% by weight of water.

In a still further aspect of the present invention, there is provided a composition suitable for the control of bacterial spot and bacterial speck diseases, the composition consisting essentially of between 0.5% and 4% by weight of a lignosulfonate and between 96% and 99.5% by weight of water.

In a still further aspect of the present invention, there is provided a composition suitable for use to control bacterial spot and bacterial speck diseases, the composition consisting essentially of between 0.5% and 4% by weight of a lignosulfonate, between about 0.5% and 4% by weight of a phosphate salt, and between 92% and 99% by weight of water.

In greater detail, lignins are a natural polymer which are generally produced as a co-product of the paper industry, the lignins being separated from the trees by a chemical pulping process. Lignosulfonates (also known as lignin sulfonates and sulfite lignins) are products of sulfite pulping. Other deligninfying technologies can use an organic solvent or high pressure steam treatment to remove lignins from plants.

As aforementioned, lignin is a very complex natural polymer, the exact chemical structure not being known. The physical and chemical properties can differ depending on the extraction technology. Lignosulfonates have generally been used for their dispersing, binding, complexing and emulsifying properties. Lignins have been used for many years and extensive studies have been done to test lignin impact on the environment. To date, lignins have been showed to be safe and not harmful to plants, animals and aquatic life when properly manufactured and applied.

Toxicology studies of lignosulfonates using laboratory animals have been conducted at the Stanford Research Institute International in California. In these studies, lignosulfonates were found to be essentially non-toxic and non-irritating, not mutagenic or genotoxic and safely used in animal and human food contact products. Lignosulfonates have also been approved for use in animal feed and various food contact materials and pesticide formulations by the U.S. Food and Drug Administration.

Lignosulfonates have also found use in various compositions used for gels and binders. Thus, lignosulfonates have been proposed as one component of various binding compositions and are particularly suitable for the plugging of wells and the like. It has also been suggested in the art that they can be used, in combination with other compounds, as a dust control composition in the manufacture of fertilizers.

The lignosulfonate used in the practice of the present invention may be any suitable although it is preferably derived from a sulphate pulping process. A particularly preferred lignosulfonate is ammonium lignosulfonate.

The lignosulfonate is present in a bactericidally effective amount which is preferably at least 0.5% by weight of the total composition. Naturally, the lignosulfonate may be present in greater amounts although preferred amounts are between 1.5% and 2.5% by weight.

The lignosulfonate is preferably foliarly sprayed on the plants to be protected from the spot and speck diseases either using a suitable carrier such as water or as a dry composition. As is known in the art, bacterial spot can affect both tomatoes and peppers while bacterial speck is also a problem with tomatoes.

The bactericidal composition may be incorporated with other materials during the spraying such as, for example, fertilizers or the like. In this respect, the lignosulfonate may be incorporated with other materials to be sprayed on the plants to be treated.

In a preferred embodiment, a monophosphate salt is incorporated in the composition. It has been found that the use of the monophosphate salt enhances the protection against bacterial spot and bacterial speck disease. The monophosphate salt is preferably present in an amount of between 0.5% and 4% by weight.

### BRIEF DESCRIPTION OF THE DRAWINGS

Having thus generally described the invention, reference will be made to the following FIGURE and to specific examples:

FIG. 1 being a graph illustrating the effect of the application of a lignosulfonate on bacterial spot severity.

### DESCRIPTION OF THE PREFERRED EMBODIMENT

The following examples are illustrative of the practice of the present invention.

### EXAMPLE 1

The efficacy of ammonium lignosulfonate to control bacterial spot of tomato on foliage was investigated in greenhouse. Three week old tomato seedlings (cultivar Bonny Best) grown in pro-mix in 10 cm pots were either topically sprayed or drenched with 4% ALS or drenched with conidial suspension of Trichoderma sp. alone or in combination with 4% ALS. The control plants were sprayed with water. Plants were spray inoculated with freshly prepared inoculum (10⁹ CFU/ml) of Xanthomonas campestris pv. vesicatoria four days after the first ALS spray. The inoculated plants were kept at greenhouse and rated for bacterial spot severity two weeks later.

Treatments:

1. Water control

2. Single ALS (4%) drench during transplanting

3. Single application of conidial suspension of Trichoderma sp. during transplanting

4. Single application of conidial suspension of Trichoderma sp. during transplanting and four drench applications of ALS (4%)

5. Three topical sprays with 4% ALS at 4-day intervals

Those plants which were sprayed with ALS showed a significantly reduced bacterial spot incidence in severity. The ALS sprayed plants showed only a few small sized necrotic spots while the remaining plants showed many necrotic spots.

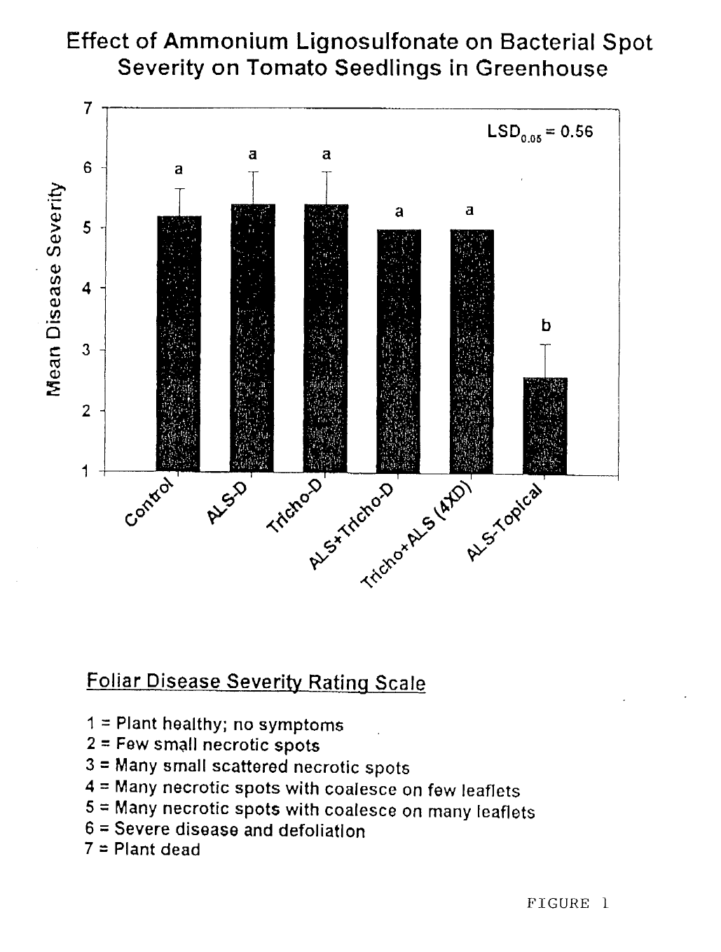

As shown in FIG. 1, there is a substantial difference in the protection afforded by the ammonium lignosulfonate.

### EXAMPLE 2

In a second trail, three rows of tomato plants were grown in an outdoor plot. The inner row of plants was treated with various percentages of ammonium lignosulfonate—at concentrations of 1%, 2% and 4% on a weight basis. Also tested were combinations of ammonium lignosulfonate and a mono phosphate salt as well as the monophosphate salt alone. Also evaluated were commercially available copper based bactericides.

As aforementioned, the inner row was treated with the various treatments while the two outer rows remained untreated as controls. The compositions were sprayed 4 times on the foliage to the point of run-off. After the growing season, the plants were evaluated for the presence of tomato spot and tomato speck disease.

In evaluating the results, the controlled plants had many necrotic spots with some suffering severe disease and defoliation. The plants sprayed with the copper based bactericide also had may necrotic spots. The monophosphate salt composition was partially effective in reducing the foliar spot disease with the plants having lignosulfonate applied thereto showing a significantly reduced disease severity. The 1% application was effective although the best results were achieved with a 2% application.

### EXAMPLE 3

This experiment as conducted at an Agricultural Research and Development Center near Fremont, OH on Colwood fine sandy loam. In May, 22.7 kg/ha 46-0-0, 63.5 kg/ha 0-0-60 and 27.2 kg/ha 18-46-0 was incorporated into the test plot. On May 22, 511 mL/ha Roundup Ultra and 341 mL/ha Dual Magnum were applied. Four week old seedlings were provided. Plastic mulch was spread and peppers were transplanted June 17; transplant water contained 170 g Diazinon AG500 plus 0.66 L 10-34-0/190 L water. Cultivars were arranged in a randomized complete block design with 4 replications. Rows were on 1.5 m centers and treatment rows were alternated with untreated border rows. Each plot was a row of 19-23 plants spaced 25 cm apart. Plants were inoculated with approximately 10⁸ cfu/ml Xanthomonas campestris pv. vesicatoria strain 110c, race T1 on the evenings of July 8 and July 23. The July 8 inoculation was applied using a tractor mounted CO₂ sprayer at 379 kPa, 56 L/ha. Plants were misted with water using a FMC sprayer with a PTO driven pump (1379 kPa, 50 L/ha) prior to inoculation. Plants were sprinkle irrigated with 1.2 cm water on July 9. Due to heavy rainfall, the July 23 inoculation was applied using a CO₂ back-pack sprayer and the plants were not misted prior to or after inoculation. Plants were irrigated with 3.6 cm water on July 16. On July 22, 68 g/ha Pounce 3.2 was applied. Treatments were applied on July 2, 11, 18, 26 and August 5 using a tractor mounted CO₂ pressurized sprayer at 379 kPa. Treatments will continue until fruit harvest. Severity of foliar bacterial leaf spot was evaluated on July 29 and August 1 and 8 using a modified Horsfall-Barratt rating scale. Disease ratings were converted to midpoints (percent disease). Severity measurements will be taken on a weekly basis until fruit harvest. At harvest, fruit will be evaluated for bacterial leaf spot and other rots. Average maximum temperatures for June 17-30 and July were 30.6 and 31.1° C.; minimum averages were 16.5 and 17.6° C.; and rainfall was 3.63 et 6.96 cm respectively.

Disease pressure was low 10 days after the first inoculation and moderate 3 days after the second inoculation. Extensive rainfall July 27-28 assisted in disease dispersal. Raw data for July 29, and August 1 and 8 evaluations can be found in Tables 1, 2, and 3 respectively.

TABLE 1

| Treatment | Rep | Plant Stand | Rate (1) | Dead Plants (2) |
|---|---|---|---|---|
| ALS-P 2% v/v | 1 | 21 | 5 | 0 |
| | 2 | 21 | 9.5 | 0 |
| | 3 | 21 | 2 | 1 |
| | 4 | 20 | 9.5 | 0 |
| ALS-P 4% v/v | 1 | 20 | 9.5 | 0 |
| | 2 | 20 | 5 | 0 |
| | 3 | 20 | 5 | 0 |
| | 4 | 20 | 2 | 1 |
| ALS-P 8% v/v | 1 | 23 | 2 | 1 |
| | 2 | 20 | 2 | 1 |
| | 3 | 22 | 2 | 0 |
| | 4 | 20 | 5 | 0 |
| ALS-L 4% v/v | 1 | 22 | 5 | 0 |
| | 2 | 19 | 2 | 0 |
| | 3 | 21 | 2 | 1 |
| | 4 | 20 | 5 | 0 |
| ALS-L 8% v/v | 1 | 22 | 2 | 0 |
| | 2 | 20 | 2 | 0 |
| | 3 | 20 | 9.5 | 0 |
| | 4 | 19 | 5 | 0 |
| Field F2 375 cc/ha + | 1 | 21 | 2 | 0 |
| Maneb 75 DF 408 g/ha | 2 | 19 | 2 | 0 |
| | 3 | 21 | 5 | 0 |
| | 4 | 21 | 5 | 0 |
| Serenade 1.08 kg/ha + | 1 | 21 | 9.5 | 0 |
| Field F2 375 cc/ha | 2 | 21 | 5 | 0 |
| | 3 | 21 | 2 | 0 |
| | 4 | 19 | 2 | 0 |
| Untreated Control | 1 | 21 | 9.5 | 0 |
| | 2 | 21 | 2 | 0 |
| | 3 | 21 | 2 | 0 |
| | 4 | 20 | 5 | 0 |

(1) bacterial leaf spot ratings derived from midpoints of a modified Horsfall-Barratt rating scale
(2) plants dead from Phytophthora blight

TABLE 2

| Treatment | Rep | Rate (1) | Dead Plants (2) |
|---|---|---|---|
| ALS-P 2% v/v | 1 | 5 | 0 |
| | 2 | 9.5 | 0 |
| | 3 | 2 | 1 |
| | 4 | 9.5 | 0 |
| ALS-P 4% v/v | 1 | 9.5 | 0 |
| | 2 | 9.5 | 0 |
| | 3 | 5 | 0 |
| | 4 | 5 | 1 |
| ALS-P 8% v/v | 1 | 5 | 1 |
| | 2 | 5 | 1 |
| | 3 | 5 | 0 |
| | 4 | 5 | 0 |
| ALS-L 4% v/v | 1 | 9.5 | 0 |
| | 2 | 9.5 | 0 |
| | 3 | 2 | 1 |
| | 4 | 5 | 0 |
| ALS-L 8% v/v | 1 | 5 | 0 |
| | 2 | 5 | 0 |
| | 3 | 9.5 | 0 |
| | 4 | 5 | 0 |
| Field F2 375 cc/ha + | 1 | 5 | 0 |
| Maneb 75 DF 408 g/ha | 2 | 2 | 0 |
| | 3 | 5 | 0 |
| | 4 | 5 | 0 |
| Serenade 1.08 kg/ha + | 1 | 9.5 | 0 |
| Field F2 375 cc/ha | 2 | 5 | 0 |
| | 3 | 2 | 0 |
| | 4 | 2 | 0 |
| Untreated Control | 1 | 9.5 | 0 |
| | 2 | 5 | 0 |
| | 3 | 5 | 0 |
| | 4 | 5 | 0 |

(1) bacterial leaf spot ratings derived from midpoints of a modified Horsfall-Barratt rating scale
(2) plants dead from Phytophthora blight

TABLE 3

| Treatment | Rep | Rate (1) | Dead Plants (2) |
|---|---|---|---|
| ALS-P 2% v/v | 1 | 9.5 | 0 |
| | 2 | 9.5 | 0 |
| | 3 | 2 | 1 |
| | 4 | 9.5 | 0 |
| ALS-P 4% v/v | 1 | 9.5 | 0 |
| | 2 | 19 | 0 |
| | 3 | 9.5 | 0 |
| | 4 | 5 | 1 |
| ALS-P 8% v/v | 1 | 5 | 1 |
| | 2 | 5 | 1 |
| | 3 | 9.5 | 0 |
| | 4 | 5 | 0 |
| ALS-L 4% v/v | 1 | 19 | 0 |
| | 2 | 9.5 | 0 |
| | 3 | 5 | 1 |
| | 4 | 9.5 | 0 |
| ALS-L 8% v/v | 1 | 19 | 0 |
| | 2 | 9.5 | 0 |
| | 3 | 9.5 | 0 |
| | 4 | 5 | 0 |
| Field F2 375 cc/ha + | 1 | 5 | 0 |
| Maneb 75 DF 408 g/ha | 2 | 2 | 0 |
| | 3 | 9.5 | 0 |
| | 4 | 5 | 0 |
| Serenade 1.08 kg/ha + | 1 | 19 | 0 |
| Field F2 375 cc/ha | 2 | 5 | 0 |
| | 3 | 5 | 0 |
| | 4 | 5 | 0 |
| Untreated Control | 1 | 19 | 0 |
| | 2 | 5 | 0 |
| | 3 | 5 | 0 |
| | 4 | 5 | 0 |

(1) bacterial leaf spot ratings derived from midpoints of a modified Horsfall-Barratt rating scale
(2) plants dead from Phytophthora blight
The above experiment was somewhat inconclusive possibly due to application of the ALS after inoculation.

### EXAMPLE 4

In this experiment, the ammonium lignosulfonate was again applied as a liquid (ALS-L) and as a powder added to water (ALS-P) to control bacterial spot on field grown peppers. The experiment was carried out on a field in Ontario with standard commercial production practices being followed and maintenance applications of approved insecticides/fungicides were applied as required. The trial was set up as a randomized complete block with four replications and the whole trial was inoculated with a culture X. canoestrus following the first application. Foliar broadcast treatments were applied on a 7-day schedule. The results are as follows.

TABLE 4
Incidence of Bacterial Spot (SB) Lesions on Peppers

| | | | | Bacterial | | Pepper | |
|---|---|---|---|---|---|---|---|
| | Treatment | Rate | | Spot Counts* | | Yield Kg | |
| 1. | ALS-P | 2% | w/v | 20.3 | abc | 2.900 | a |
| 2. | ALS-P | 4% | w/v | 15.3 | bc | 2.865 | a |
| 3. | ALS-P | 8% | w/v | 14.3 | bc | 3.203 | a |
| 4. | ALS-L | 4% | v/v | 17.3 | bc | 3.275 | a |
| 5. | ALS-L | 8% | v/v | 22.5 | ab | 2.790 | a |
| 6. | Kocide 101 + | 2.25 | kg/ha + | 12.5 | c | 3.260 | a |
| | Bravo | 2.0 | L/ha | | | | |

| | | | | | | |
|---|---|---|---|---|---|---|
| 7. | Control | No treatment | 27.3 | a | 2.625 | a |
| | LSD (P = .05)** | | 7.96 | | 0.765 | |

*Bacterial Spot Counts on foliage
**Means followed by the same letter do not significantly differ (P = .05. Duncan's New MRT)

The ALS powder formulations significantly reduced the number of bacterial spot lesions on the foliage when applied at the 4 and 8% w/v concentrations. Disease counts were 14-15 compared to 27 in the control. ALS liquid treatments were less effective than the powder form, but slightly better than the control. The most effective treatment was the standard of Kocide+Bravo, which was slightly better than ALS-P at 4 and 8%, but not significantly so. There was no significant difference in yield of peppers; however, the most efficacious treatments tended towards higher pepper weight.

### EXAMPLE 5

In this trial, tomatoes of the variety “Pink Girl” were conducted on a basis similar to that set forth in Example 4. The transplanted tomatoes were planted in 1 m rows in a plot size of 3 rows by 8 meters and using a randomized complete block with four replications. The results are set forth in Table 5.

TABLE 5
Incidence of Bacterial Spot (BS) Lesions on Foliage and Stems

| | | | | BS | | BS | | | |
|---|---|---|---|---|---|---|---|---|---|
| | | | | Incidence | | Incidence | | Crop | |
| | Treatment | Rate | | Foliage* | | Stems* | | Vigour | |
| 1. | ALS-L | 2% | v/v | 37.5 | ab | 7.5 | b | 4.50 | a |
| 2. | ALS-L | 4% | v/v | 17.5 | b | 2.5 | b | 4.75 | a |
| 3. | ALS-L | 8% | v/v | 47.5 | ab | 12.5 | b | 4.63 | a |
| 4. | ALS-P | 2% | w/v | 32.5 | ab | 2.5 | b | 4.50 | a |
| 5. | ALS-P | 4% | w/v | 5.0 | b | 2.5 | b | 4.50 | a |
| 6. | Kocide/ | 2.25/ | | 5.0 | b | 0.0 | b | 4.38 | a |
| | mancozeb | 2.25 | kg/ha | | | | | | |

| | | | | | | | | |
|---|---|---|---|---|---|---|---|---|
| 7. | Control | No treatment | 85.0 | a | 53.5 | a | 4.63 | a |
| | LSD (P = .05)** | | 39.08 | | 16.35 | | 0.74 | |

*BS Incidence = % of plants with disease symptoms
**Means followed by the same letter do not significantly differ (P = .05. Student-Neuman-Keuls)

The inoculation was successful and resulted in the appearance of foliar and stem disease symptoms on 85% and 53.5% of control plants, respectively. The commercial standard sprays, Kocide (copper)/mancozeb, effectively reduced disease incidence on leaves (5.0%) and stems (0.0%). Applications of ALS-P (4%) were equally as effective as the standard in reducing disease incidence on leaves and stems. ALS-L (4%) also significantly reduced infection levels on leaves and stems. Although all ALS treatments reduced stem infections, the ALS-L (4% v/v) and ALS-P (4% w/v) treatments reduced both stem and leaf infections, with the powder formulation tending to be slightly more efficacious. Inexplicably, the ALS-L (8%) treatment was inferior to the lower rate treatments. There was no difference in the vigour of plant growth attributable to the treatments.

### EXAMPLE 6

Evaluation of ammonium lignosulfonate.

This experiment is similar to that of Example 4 and was conducted under similar conditions. The results are as follows.

TABLE 6
Incidence of Bacterial Spot (BS) on Tomatoes

| | | | | Bacterial | | Foliage | |
|---|---|---|---|---|---|---|---|
| | | | | Colony | | Disease | |
| | Treatment | Rate | | Counts* | | Rating** | |
| 1. | ALS-P | 2% | w/v | 29.5 | b | 8.0 | ab |
| 2. | ALS-P | 4% | w/v | 22.5 | b | 6.8 | bc |
| 3. | ALS-P | 8% | w/v | 27.3 | b | 7.3 | bc |
| 4. | ALS-L | 4% | v/v | 29.3 | b | 6.0 | bc |
| 5. | ALS-L | 8% | v/v | 27.0 | b | 7.0 | bc |
| 6. | Kocide 101 + | 2.25 | kg/ha + | 11.3 | c | 9.3 | a |
| | Bravo | 2.0 | L/ha | | | | |

| | | | | | | |
|---|---|---|---|---|---|---|
| 7. | Control | No treatment | 45.3 | a | 6.5 | bc |
| | LSD (P = .05)*** | | 10.05 | | 1.43 | |

*Bacterial Colony Counts on foliage
**Foliar Disease: 10 = healthy foliage, no infection. 0 = high level of infection and dieback
***Means followed by the same letter do not significantly differ (P = .05. Duncan's New MRT)

All ALS treatments significantly reduced the incidence of bacterial spot lesions on tomato foliage. Although not statistically different, application of ALS-P at 4% tended to provide better control than other ALS treatments. The standard chemical treatment of Kocide+Bravo provided the best control of bacterial spot which resulted in the appearance of healthier foliage in those plots.

### EXAMPLE 7

This experiment is similar to that of Example 6 except that the evaluation is done for bacterial speck. Similar protocoles were followed.

TABLE 7
Incidence of Bacterial Speck on Tomatoes

| | | | | Bacterial | |
|---|---|---|---|---|---|
| | Treatment | Rate | | Colony Counts* | |
| 1. | ALS-P | 2% | w/v | 6.5 | b |
| 2. | ALS-P | 4% | w/v | 6.3 | b |
| 3. | ALS-P | 8% | w/v | 8.0 | ab |
| 4. | ALS-L | 4% | v/v | 6.8 | b |
| 5. | ALS-L | 8% | v/v | 7.3 | b |
| 6. | Kocide 101 + | 2.25 | kg/ha + | 2.3 | c |
| | Bravo | 2.0 | L/ha | | |

| | | | | |
|---|---|---|---|---|
| 7. | Control | No treatment | 9.3 | a |
| | LSD (P = .05)** | | 1.73 | |

*Bacterial Colony Counts on foliage
**Means followed by the same letter do not significantly differ (P = .05. Duncan's New MRT)

As will be seen from the above, the use of the lignosulfonate applied as a foliar applicant does reduce the incidence of bacterial spot and bacterial speck.

It will be understood that the above described embodiments are for purposes of illustration only and that changes or modifications may be made thereto without departing from the spirit and scope of the invention.

I claim:

1. A method for the control of bacterial spot, the method comprising the step of foliarly spraying on a plant on which said bacterial spot is to be controlled a bactericidally effective amount of a lignosulfonate.

2. The method of claim 1 wherein the step of foliarly spraying a bactericidally effective of a lignosulfonate comprising the step of spraying a composition comprising between about 95% to 99.5% by weight of water and between 0.5% and 5% by weight of said lignosulfonate.

3. The method of claim 1 wherein said plant is a tomato plant.

4. The method of claim 1 further including foliarly spraying on said plant said lignosulfonate between 2 and 4 times during a growing season.

5. The method of claim 2 wherein said composition further includes a monophosphate salt present in an amount of between 0.5% and 4% by weight

6. The method of claim 1 wherein said lignosulfonate is ammonium lignosulfonate.

7. The method of claim 4 wherein said monophosphate salt is present in an amount of between 0.5% and 4% by weight in said composition.

8. A method for the control of bacterial speck, the method comprising the step of foliarly spraying on a plant on which said bacterial speck is to be controlled a bactericidally effective amount of a lignosulfonate.

9. The method of claim 8 wherein the step of spraying a bactericidally effective amount of a lignosulfonate comprises the step of spraying a composition comprising between 0.5% and 4% by weight of said lignosulfonate, and between 95% to 99.5% by weight of water.

10. The method of claim 8 wherein said plant is a tomato plant.

11. The method of claim 8 including foliarly spraying on said plant said composition between 2 and 4 times during a growing season.

12. The method of claim 9 wherein said composition further includes a phosphate salt present in an amount of between 0.5% and 4% by weight.

13. The method of claim 8 wherein said lignosulfonate is ammonium lignosulfonate.

14. A composition suitable for the control of bacterial spot and bacterial speck diseases, the composition consisting essentially of between 0.5% and 4% by weight of a lignosulfonate and between 95% to 99.5% by weight of water.

15. The composition of claim 14 additionally containing between 0.5% and 4% by weight of a phosphate salt.
